(19) United States
(12) Patent Application Publication
(10) Pub. No.: US 2010/0087258 A1
(43) Pub. Date: Apr. 8, 2010

(54) INFORMATION STORAGE MEDIUM, GAME SYSTEM, AND METHOD OF CONTROLLING GAME SYSTEM

(75) Inventor: Jun MORIWAKI, Tokyo (JP)

Correspondence Address: OLIFF & BERRIDGE, PLC, P.O. BOX 320850, ALEXANDRIA, VA, 22320-4850, US

(73) Assignee: NAMCO BANDAI GAMES INC., Tokyo (JP)

(21) Appl. No.: 12/572,579

(22) Filed: Oct. 2, 2009

(30) Foreign Application Priority Data
Oct. 8, 2008 (JP) 2008-262204

(51) Int. Cl. A63F 9/24; A63F 13/00

(52) U.S. Cl. 463/43; 463/35

(57) ABSTRACT

A game system includes: a music reproduction section that reproduces music data stored in a storage section; a character display control section that displays a character disposed on a map; a timing mark display control section that displays a timing mark in relation to the character, the timing mark indicating an evaluation timing that is set according to the music data; an input timing acquisition section that acquires an input timing of an input through an operation section; and an evaluation section that evaluates an operation of a player based on the acquired input timing and the evaluation timing, and the character display control section changes a motion of the character based on an evaluation result of the evaluation section.

Japanese Patent Application No. 2008-262204, filed on Oct. 8, 2008, is hereby incorporated by reference in its entirety.

### BACKGROUND OF THE INVENTION

The present invention relates to an information storage medium, a game system, and a method of controlling a game system.

A music game device that displays an instruction mark that moves with the music to instruct the player to perform an operation input at a timing (evaluation timing) when the instruction mark has reached an evaluation position has been known (see JP-A-2007-181650, for example).

In such a game device, the instruction mark is merely moved on a game screen along a predetermined moving path, but is not displayed to follow a game character.

### SUMMARY

According to a first aspect of the invention, there is provided a computer-readable information storage medium storing a program that causes a computer to function as:

a music reproduction section that reproduces music data stored in a storage section;

a character display control section that displays a character disposed on a map;
a timing mark display control section that displays a timing mark in relation to the character, the timing mark indicating an evaluation timing that is set according to the music data;

an input timing acquisition section that acquires an input timing of an input through an operation section; and

an evaluation section that evaluates an operation of a player based on the acquired input timing and the evaluation timing,

the character display control section changing a motion of the character based on an evaluation result of the evaluation section.

According to a second aspect of the invention, there is provided a game system comprising:

a music reproduction section that reproduces music data stored in a storage section;

a character display control section that displays a character disposed on a map;

a timing mark display control section that displays a timing mark in relation to the character, the timing mark indicating an evaluation timing that is set according to the music data;

an input timing acquisition section that acquires an input timing of an input through an operation section; and

an evaluation section that evaluates an operation of a player based on the acquired input timing and the evaluation timing,

the character display control section changing a motion of the character based on an evaluation result of the evaluation section.

According to a third aspect of the invention, there is provided a method of controlling a game system, the method comprising:

reproducing music data stored in a storage section;

displaying a character disposed on a map;

displaying a timing mark in relation to the character, the timing mark indicating an evaluation timing that is set according to the music data;

acquiring an input timing of an input through an operation section;

evaluating an operation of a player based on the acquired input timing and the evaluation timing; and

changing a motion of the character based on an evaluation result for the operation of the player.

### BRIEF DESCRIPTION OF THE SEVERAL VIEWS OF THE DRAWING

FIG. 1 illustrates an example of functional blocks of a game system according to one embodiment of the invention.

FIG. 2 is a diagram illustrating a method according to one embodiment of the invention.

FIG. 3 is a diagram illustrating a method according to one embodiment of the invention.

FIGS. 4A and 4B are diagrams illustrating a method according to one embodiment of the invention.

FIGS. 5A and 5B are diagrams illustrating a method according to one embodiment of the invention.

FIG. 6 is a diagram illustrating a method according to one embodiment of the invention.

FIG. 7 is a diagram illustrating a method according to one embodiment of the invention.

FIG. 8 is a diagram illustrating a method according to one embodiment of the invention.

FIGS. 9A and 9B are diagrams illustrating a method according to one embodiment of the invention.

FIG. 10 is a diagram illustrating a method according to one embodiment of the invention.

FIG. 11 is a flowchart illustrating an example of a process according to one embodiment of the invention.

FIG. 12 is a diagram illustrating a modification.

FIG. 13 is a diagram illustrating another modification.

### DETAILED DESCRIPTION OF THE EMBODIMENT

The invention may provide an information storage medium, a game system, and a method of controlling a game system that implement a music game that allows the player to perform an operation input while watching a timing mark displayed in relation to a character,

(1) According to one embodiment of the invention, there is provided a computer-readable information storage medium storing a program that causes a computer to function as:

a music reproduction section that reproduces music data stored in a storage section;

a character display control section that displays a character disposed on a map;

a timing mark display control section that displays a timing mark in relation to the character, the timing mark indicating an evaluation timing that is set according to the music data;

an input timing acquisition section that acquires an input timing of an input through an operation section; and

an evaluation section that evaluates an operation of a player based on the acquired input timing and the evaluation timing,

the character display control section changing a motion of the character based on an evaluation result of the evaluation section.

According to one embodiment of the invention, there is provided a game system comprising the above-described sections.

According to the above embodiments, a music game in which the motion of the character changes based on the evaluation result for an operation input according to the timing mark that is displayed in relation to the character can be implemented.

(2) In the above information storage medium,

the evaluation section may detect a difference between the input timing and the evaluation timing; and

the character display control section may determine the motion of the character based on the difference between the input timing and the evaluation timing.

According to the above configuration, the motion of the character can be changed depending on the difference between the input timing and the evaluation timing.

(3) In the above information storage medium,

the character display control section may change a motion of a target character based on the evaluation result of the evaluation section; and

the timing mark display control section may display the timing mark in relation to the target character.

Note that the term “target character” refers to a character that appears in the game and is attacked by the player or a player's character.

According to the above configuration, a music game in which the motion of the target character changes based on the evaluation result for the operation input according to the timing mark that is displayed in relation to the target character can be implemented.

(4) In the above information storage medium,

the evaluation section may detect a difference between the input timing and the evaluation timing; and

the character display control section may determine the motion of the target character based on the difference between the input timing and the evaluation timing.

According to the above configuration, the motion of the target character can be changed depending on the difference between the input timing and the evaluation timing.

(5) In the above information storage medium,

the character display control section may display a plurality of the target characters in different patterns based on the evaluation result of the evaluation section.

Note that the pattern in which the target character is displayed refers to the type, the number, the position, or the order of the target characters to be displayed, for example.

According to the above configuration, the game process can be changed based on the operation input evaluation result.

(6) In the above information storage medium,

the character display control section may display an effect image in relation to the target character based on the evaluation result of the evaluation section.

According to the above configuration, the player can be simply notified of the operation input evaluation result.

(7) In the above information storage medium,

the timing mark display control section may successively or gradually change the timing mark until the evaluation timing is reached.

According to the above configuration, the player can be notified of the time that remains until the evaluation timing is reached.

(8) In the above information storage medium,

the timing mark display control section may change the timing mark at the evaluation timing.

The timing mark may be successively or gradually changed until the evaluation timing is reached, and may be changed again when the evaluation timing has been reached.

According to the above configuration, the player can be notified of the evaluation timing.

(9) In the above information storage medium,

the character display control section may change a motion of a player's character based on the evaluation result of the evaluation section.

According to the above configuration, a music game in which the motion of the player's character changes based on the evaluation result for the operation input according to the timing mark displayed in relation to the target character can be implemented.

(10) The above information storage medium may store a program that causes the computer to further function as:

a virtual camera control section that controls a virtual camera that generates an image viewed from a given viewpoint in an object space,

wherein the virtual camera control section controls the virtual camera based on the evaluation result of the evaluation section.

According to the above configuration, a music game in which the viewpoint position, the line-of-sight direction, or the like of the virtual camera changes based on the evaluation result for the operation input according to the timing mark that is displayed in relation to the target character can be implemented.

(11) The above information storage medium may store a program that causes the computer to further function as:

a sound generation section that generates game sound based on the evaluation result of the evaluation section.

According to the above configuration, the player can be notified of the operation input evaluation result by means of the game sound.

(12) According to one embodiment of the invention, there is provided a method of controlling a game system, the method comprising:

reproducing music data stored in a storage section;

displaying a character disposed on a map;

displaying a timing mark in relation to the character, the timing mark indicating an evaluation timing that is set according to the music data;

acquiring an input timing of an input through an operation section;

evaluating an operation of a player based on the acquired input timing and the evaluation timing; and

changing a motion of the character based on an evaluation result for the operation of the player.

Some embodiments of the invention will now be described below. Note that the embodiments described below do not unduly limit the scope of the invention as stated in the claims. Also, not all the elements described below should be taken as essential requirements of the invention.

### 1. Configuration

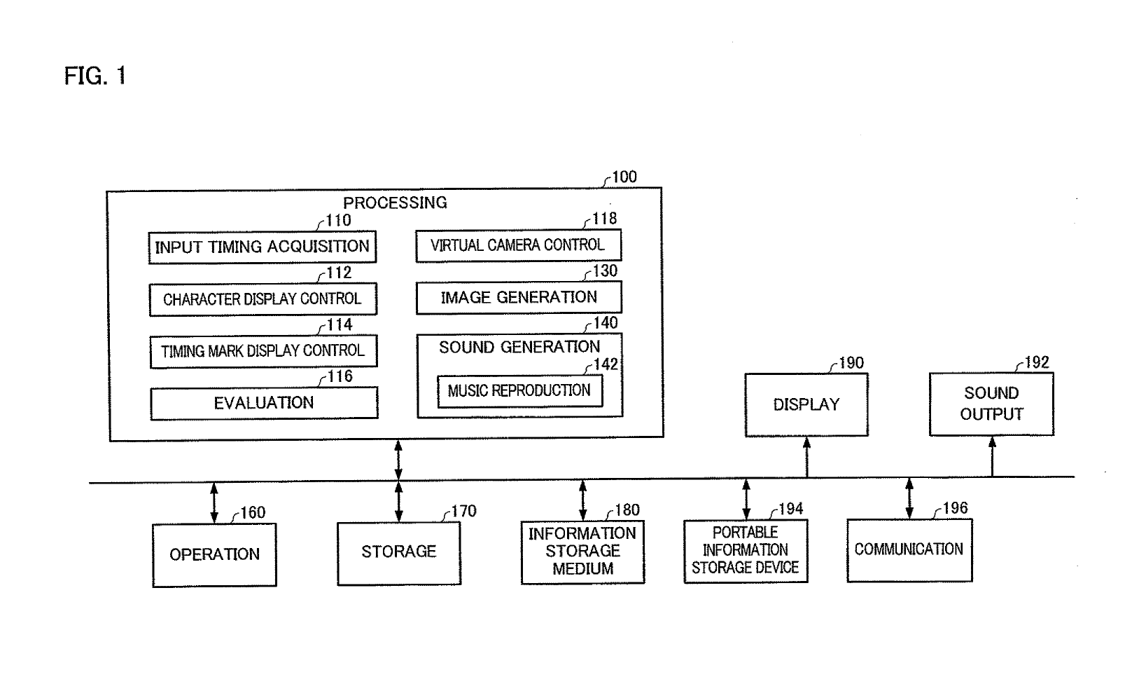

FIG. 1 illustrates an example of a functional block diagram of a game system according to one embodiment of the invention. Note that the game system according to this embodiment may have a configuration in which some of the elements (sections) illustrated in FIG. 1 are omitted.

An operation section 160 allows the player to input operation data. The function of the operation section 160 may be implemented by a button, an arrow key, a lever, a touch panel display, an indicator (pointing device) that indicates an arbitrary position on a display screen, a casing, or the like.

A storage section 170 serves as a work area for a processing section 100, a communication section 196, and the like. The function of the storage section 170 may be implemented by a RAM or the like.

The storage section 170 according to this embodiment stores music data, game sound (effect sound), and the like. The storage section 170 also stores image data and object information that indicate a display object (e.g., target character, player's character, or timing mark). The storage section 170 also stores a plurality of pieces of motion data for causing the target character and the player's character to make a motion. The storage section 170 also stores pattern data that specifies the types, the number, the positions, and the order of the target characters to be displayed, a moving path of the player's character on a map, and the like in relation to the music data. The storage section 170 also stores timing data that specifies an evaluation timing and a target character corresponding to the evaluation timing in relation to the music data.

An information storage medium 180 (computer-readable medium) stores a program, data, and the like. The function of the information storage medium 180 may be implemented by an optical disk (CD or DVD), a magneto-optical disk (MO), a magnetic disk, a hard disk, a magnetic tape, a memory (ROM), or the like. The processing section 100 executes various processes according to this embodiment based on a program (data) stored in the information storage medium 180. A program that causes a computer to function as each section according to this embodiment (i.e., a program that causes a computer to execute the process of each section) may be stored in the information storage medium 180.

A display section 190 outputs an image generated according to this embodiment. The function of the display section 190 may be implemented by a CRT, an LCD, a touch panel display, a head mount display (HMD), or the like.

A sound output section 192 outputs sound generated according to this embodiment. The function of the sound output section 192 may be implemented by a speaker, a headphone, or the like.

A portable information storage device 194 stores a player's personal data, saved game data, and the like. A memory card or the like may be used as the portable information storage device 194.

The communication section 196 performs various types of control for communicating with the outside (e.g., another game device or server) through a network. The function of the communication section 196 may be implemented by hardware such as a processor or a communication ASIC, a program, or the like.

Note that the game system may receive a program (data) that causes a computer to function as each section according to this embodiment from an information storage medium or a storage section of a server through a network, and may store the program (data) in the information storage medium 180 or the storage section 170. A case where the game system operates based on the program (data) received from the server is also included within the scope of the invention.

The processing section 100 (processor) executes a game process, an image generation process, a sound generation process, and the like based on operation data from the operation section 160, a program, and the like. The game process includes starting the game when game start conditions have been satisfied, proceeding with the game, disposing an object such as a character or a map, displaying an object, calculating the game result, finishing the game when game end conditions have been satisfied, and the like. The processing section 100 executes various processes using the storage section 170 as a work area. The function of the processing section 100 may be implemented by hardware such as a processor (e.g., CPU or DSP) or an ASIC (e.g., gate array), or a program.

The processing section 100 includes an input timing acquisition section 110, a character display control section 112, a timing mark display control section 114, an evaluation section 116, a virtual camera control section 118, an image generation section 130, and a sound generation section 140. Note that some of these sections may be omitted.

The input timing acquisition section 110 acquires operation data input using the operation section 160. The input timing acquisition section 110 also acquires an input timing of an operation performed using the operation section 160.

The character display control section 112 displays a character (i.e., the target character and the player's character disposed on a map disposed in an object space). The character display control section 112 calculates the movement/motion of the character (object) (movement/motion simulation). Specifically, the character display control section 112 causes the object to move or make a motion (animation) in the object space based on the operation data input by the player using the operation section 160, a program (movement/motion algorithm), various types of data (motion data), a physical law, and the like. More specifically, the character display control section 112 performs a simulation process that sequentially calculates movement information (position, rotational angle, speed, or acceleration) and motion information (i.e., the position or the rotational angle of each part that forms the object) about the object every frame ( 1/60th of a second). Note that the term “frame” refers to a time unit when performing an object movement/motion process (simulation process) or an image generation process.

The timing mark display control section 114 displays a timing mark in relation to the character (target character or player's character), the timing mark indicating an evaluation timing that is set according to the music data.

The timing mark display control section 114 may successively or gradually change the display state of the timing mark until the evaluation timing is reached. The term “display state” of the timing mark used herein refers to the size, shape, or color of the timing mark, a character or a figure displayed on the timing mark, and the like.

The timing mark display control section 114 may change the display state of the timing mark at the evaluation timing.

The evaluation section 116 evaluates the operation of the player based on the input timing acquired by the input timing acquisition section 110 and the evaluation timing.

The character display control section 112 may change the motion of the target character or the player's character (e.g., reproduction target motion data) based on the evaluation result of the evaluation section 116.

The evaluation section 116 detects the difference (magnitude of the difference) between the input timing and the evaluation timing, and evaluates the operation of the player based on the difference between the input timing and the evaluation timing. The character display control section 112 may determine the motion of the target character or the player's character based on the difference between the input timing and the evaluation timing.

The character display control section 112 may display a plurality of target characters in a different pattern based on the evaluation result of the evaluation section 116. Note that the pattern in which the target characters are displayed refers to the types, the number, the positions, or the order of the target characters to be displayed, for example.

The character display control section 112 may display an effect image in relation to the target character based on the evaluation result of the evaluation section 116. The effect image may be an image that indicates a character or a figure corresponding to the evaluation result, or may be a particle image.

The virtual camera control section 118 controls a virtual camera (viewpoint) for generating an image viewed from a given (arbitrary) viewpoint in the object space. Specifically, the virtual camera control section 118 controls the position (X, Y, Z) or the rotational angle (e.g., the rotational angle of the virtual camera when the virtual camera is rotated clockwise around each of the X, Y, and Z axes) of the virtual camera in a world coordinate system based on operation data input by the player using the operation section 160, a program (movement/motion algorithm), and the like. Specifically, the virtual camera control section 118 controls the viewpoint position, the line-of-sight direction, and the angle of view.

The virtual camera control section 118 controls the virtual camera based on the evaluation result of the evaluation section 116. The virtual camera control section 118 may control the virtual camera based on the difference between the input timing and the evaluation timing.

The image generation section 130 executes a drawing process based on the results of various processes (game process) executed by the processing section 100 to generate an image, and outputs the generated image to the display section 190. When the image generation section 130 according to this embodiment generates a three-dimensional game image, the image generation section 130 receives object data (model data) including vertex data (e.g., vertex position coordinates, texture coordinates, color data, normal vector, or alpha value) about each vertex of the object (model), and executes a vertex process based on the vertex data included in the input object data. The image generation section 130 may execute a vertex generation process (tessellation, curved surface division, or polygon division) for polygon subdivision when executing the vertex process, if necessary.

In the vertex process, the image generation section 130 executes a vertex movement process and a geometric process such as coordinate transformation (world coordinate transformation or camera coordinate transformation), clipping, perspective transformation, or a light source process, and changes (updates or adjusts) the vertex data about the vertices of the object based on the process results. The image generation section 130 then performs a rasterization process (scan conversion) based on the vertex data changed by the vertex process so that the surface of the polygon (primitive) is associated with pixels. The image generation section 130 then executes a pixel process (fragment process) that draws pixels that form the image (fragments that form the display screen).

In the pixel process, the image generation section 130 determines the final drawing color of the pixel of the image by executing a texture reading process (texture mapping), a color data setting/change process, a translucent blending process, an anti-aliasing process, and the like, and outputs (draws) the drawing color of the object subjected to perspective transformation to a frame buffer (i.e., a buffer that can store image information in pixel units; VRAM or rendering target). Specifically, the pixel process includes a per-pixel process that sets or changes the image information (e.g., color, normal, luminance, and alpha value) in pixel units.

The image generation section 130 thus generates an image viewed from the virtual camera (given viewpoint) set in the object space. When a plurality of virtual cameras (viewpoints) are provided, the image generation section 130 may generate an image so that images (divided images) viewed from the respective virtual cameras are displayed on one screen.

The sound generation section 140 executes a sound process based on the results of various processes executed by the processing section 100 to generate game sound such as background music (BGM), effect sound, or voice, and outputs the generated game sound to the sound output section 192.

The sound generation section 140 includes a music reproduction section 142. The music reproduction section 142 reproduces the music data stored in the storage section 170.

The sound generation section 140 may generate the game sound based on the evaluation result of the evaluation section 116. The sound generation section 140 may generate the game sound based on the difference between the input timing and the evaluation timing.

2. Method According to this Embodiment

A method according to this embodiment is described below with reference to the drawings.

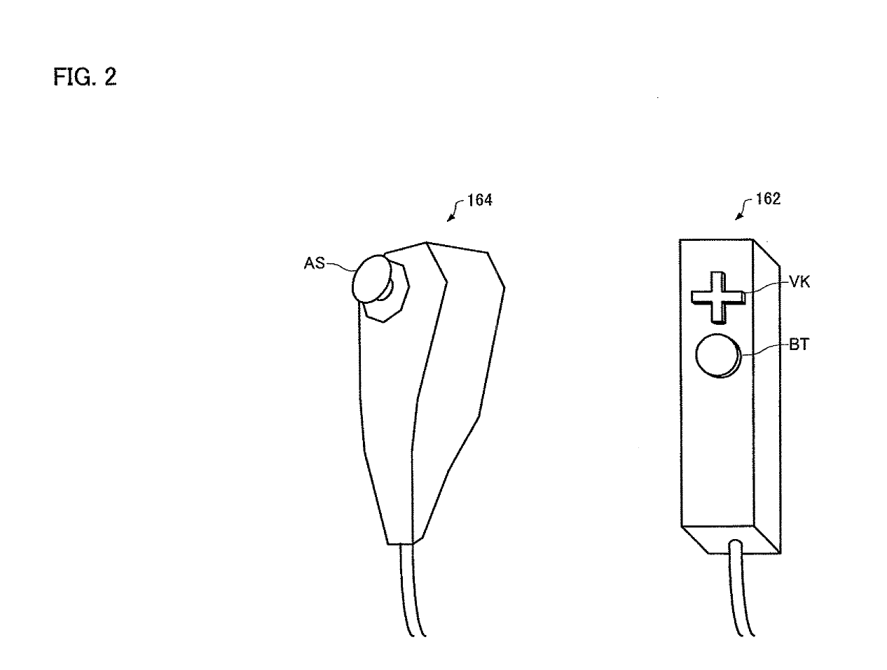

FIG. 2 is a diagram illustrating an example of the operation section according to this embodiment.

The player operates a first controller 162 illustrated in FIG. 2 while holding the first controller 162 with the right hand. The first controller 162 includes an arrow key VK, a button BT, and the like. The player operates a second controller 164 while holding the second controller 164 with the left hand. The second controller 164 includes an analog stick AS, a button (not shown), and the like.

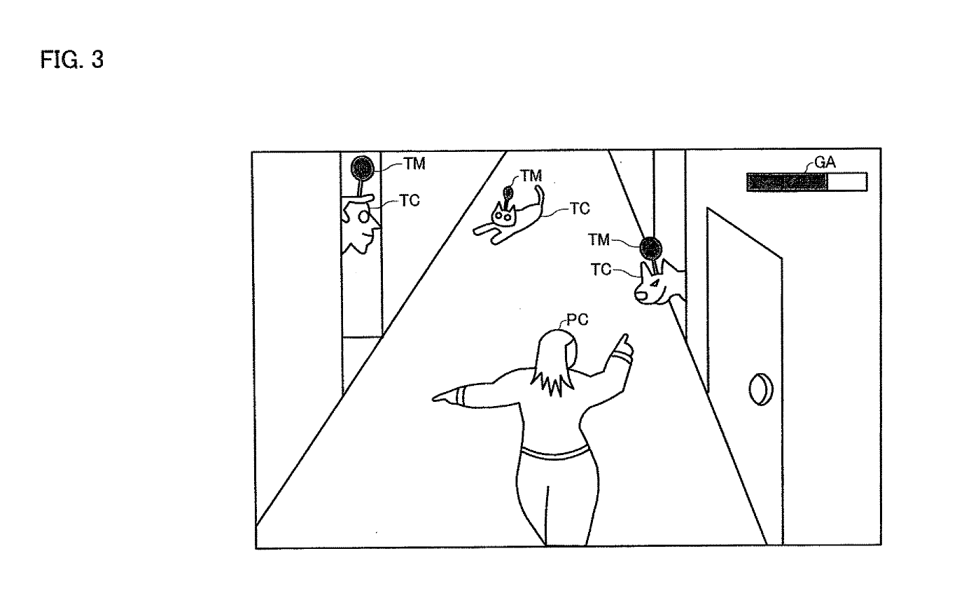

FIG. 3 is a diagram illustrating an example of a game screen according to this embodiment.

In this embodiment, a player's character PC and a plurality of target characters TC (i.e., non-player characters (NPC) attacked by the player's character PC) are disposed on a map disposed in the object space. The map according to this embodiment forms a game stage that imitates a virtual town. The target characters TC are disposed on the map according to pattern data (i.e., data that specifies the position, the appearance timing, and the like of each target character TC on the map) corresponding to the reproduced music data. The player's character TC moves along a path (course) on the map corresponding to the reproduced music data.

As illustrated in FIG. 3, a game screen in which the player's character PC moves along the path on the map is displayed. The target characters TC disposed on the map appear one after another as the player's character PC moves along the path on the map (moves forward on the game screen illustrated in FIG. 3). Note that an NPC other than the target character may be disposed on the map, and the target character TC may be disposed behind the NPC.

In this embodiment, a timing mark TM (an image that indicates a balloon in the example illustrated in FIG. 3) that indicates the evaluation timing set according to the reproduced music data is displayed in relation to each target character TC.

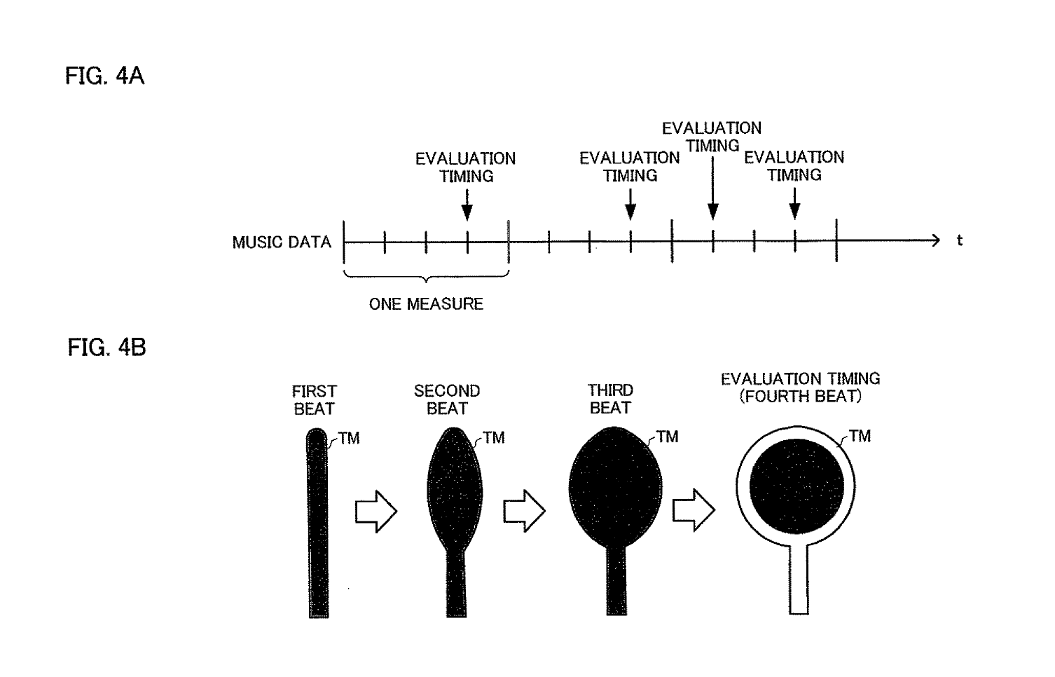

A plurality of evaluation timings are set for each piece of music data according to the rhythm of the music. In the example illustrated in FIG. 4A, the evaluation timings are set at the second beat and the fourth beat in four-four time. The evaluation timings respectively correspond to the timing marks TM of the target characters TC.

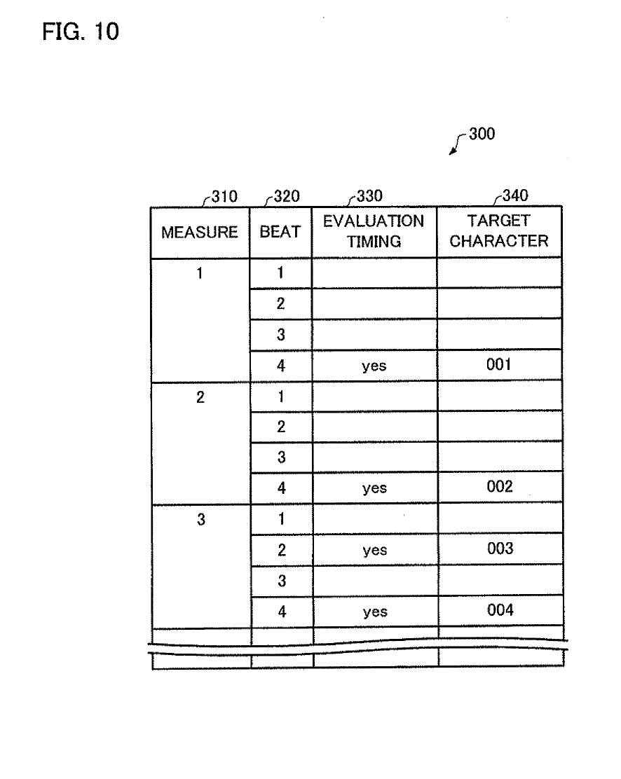

As illustrated in FIG. 10, timing data 300 that includes data 330 that indicates the presence or absence of the evaluation timing in each measure 310 and at each beat 320 of the music data, and data 340 that indicates the target character corresponding to each evaluation timing, is stored in the storage section, and each evaluation timing is associated with the timing mark TM of the target character TC based on the timing data 300.

In this embodiment, the nth evaluation timing in the time-series is associated with the timing mark TM of the target character TC that is nth closest to the player's character PC (i.e., the nth target character TC that the player's character PC encounters), and the (n+1)th evaluation timing is associated with the timing mark TM of the target character TC that is (n+1)th closest to the player's character PC.

In this embodiment, the display state of the timing mark is successively or gradually changed until the evaluation timing is reached, and is further changed at the evaluation timing.

As illustrated in FIG. 4B, when the evaluation timing is set at the fourth beat in four-four time, the shape (i.e., one display state) of the timing mark TM that indicates a balloon is successively changed so that the timing mark TM gradually expands from the first beat and completely expands on the fourth beat. The display state of the timing mark TM is changed so that the luminance of the periphery of the timing mark TM increases at the fourth beat (i.e., evaluation timing). Therefore, the player can be reliably notified of the evaluation timing.

The player can cause the player's character PC to attack the target character TC by operating the operation section. Specifically, when the player has operated the button of the first controller, a beam is emitted from the right hand (finger) of the player's character PC. When the player has operated the button of the second controller, a beam is emitted from the left hand (finger) of the player's character PC. Note that the beam is emitted toward the target character TC (attack target character TC) that is positioned closest to the player's character PC.

The player operates the operation section at the evaluation timing indicated by the timing mark TM of the target character TC that is positioned closest to the player's character PC while watching the timing marks TM of the target characters TC that appear on the game screen one after another, so that the player can attack the target characters TC one after another according to the rhythm of the music.

In this embodiment, the operation of the player is evaluated based on the operation input timing of the player and the evaluation timing, and the operations of the target character and the player's character are changed based on the evaluation result. In this embodiment, an effect image is displayed in relation to the target character based on the operation evaluation result.

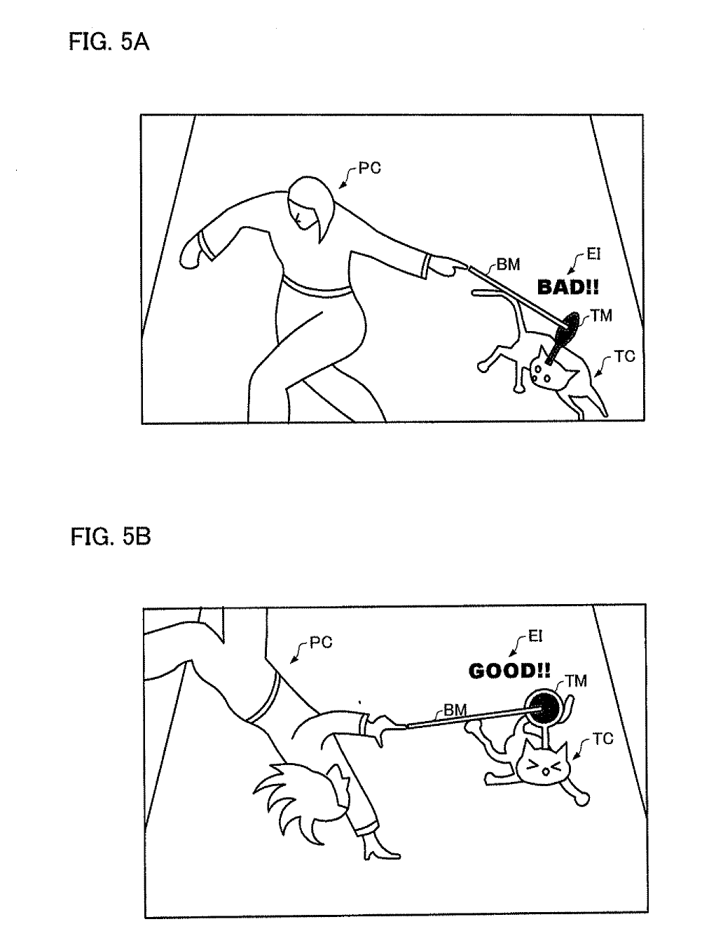

As illustrated in FIG. 5A, when the player has operated the button at a timing when the timing mark TM (balloon) of the attack target character TC has not completely expanded (i.e., a timing other than the evaluation timing), the player's character PC attacks the target character TC while making a normal motion, and the target character TC is subjected to the attack while making a normal motion. Specifically, the normal motion is selected and reproduced from a plurality of motions of the player's character PC, and the normal motion is selected and reproduced from a plurality of motions of the target character TC. An effect image EI that indicates a poor evaluation result is displayed near the attack target character TC.

As illustrated in FIG. 5B, when the player has operated the button at a timing when the timing mark TM (balloon) of the attack target character TC has completely expanded (i.e., a timing close to the evaluation timing), the player's character PC attacks the target character TC while making a special motion differing from the normal motion, and the target character TC is subjected to the attack while making a special motion (i.e., a motion that represents damage due to the attack) differing from the normal motion. Specifically, the special motion is selected and reproduced from a plurality of motions of the player's character PC, and the special motion is selected and reproduced from a plurality of motions of the target character TC. An effect image EI that indicates a good evaluation result is displayed near the attack target character TC. Note that the player's character and the target character may be caused to make a motion by displaying an animation (i.e., a plurality of images are sequentially displayed) or displaying a single image.

The player can thus visually check the operation evaluation result, and enjoy the game in which the operations of the player's character PC and the target character TC change depending on the evaluation result.

In this embodiment, the operation of the player is evaluated stepwise based on the temporal difference between the operation input timing of the player and the evaluation timing.

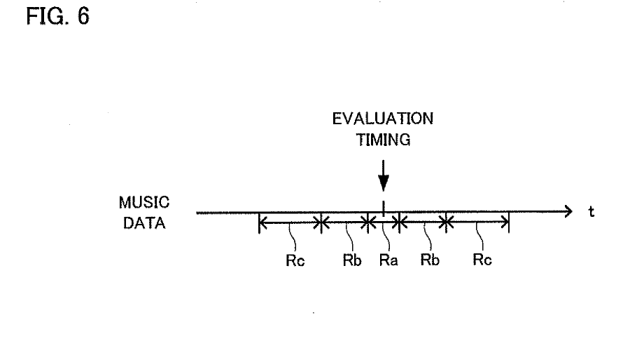

As illustrated in FIG. 6, when the operation input timing is included within a range Ra in which the difference from the evaluation timing is a minimum, the player is evaluated to be “A” (i.e., top rating), for example. When the operation input timing is included within a range Rb in which the difference from the evaluation timing is average, the player is evaluated to be “B”. When the operation input timing is included within a range Rb in which the difference from the evaluation timing is a maximum, the player is evaluated to be “C” (i.e., worst rating).

In this embodiment, the evaluation result based on the difference between the input timing and the evaluation timing determines the motions of the target character and the player's character, the effect image to be displayed, the game sound to be generated, and points.

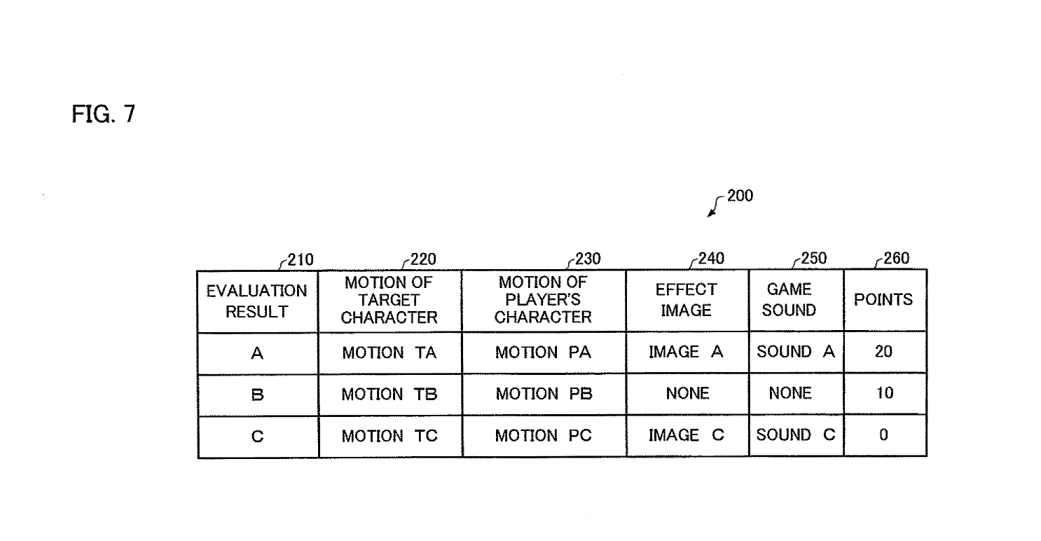

FIG. 7 illustrates an evaluation table that specifies the motion of the character and the like corresponding to the evaluation result. In relation to each evaluation result 210, an evaluation table 200 specifies a motion 220 of the target character, a motion 230 of the player's character, an effect image 240 that is displayed in relation to the target character, a game sound 250 to be generated, and points 260 given to the player.

For example, when the evaluation result 210 is “A”, the motion 220 of the target character is determined to be “motion TA”, the motion 230 of the player's character is determined to be “motion PA”, and the target character TC and the player's character PC are caused to make a motion as illustrated in FIG. 5B. When the evaluation result 210 is “C”, the motion 220 of the target character is determined to be “motion TC”, the motion 230 of the player's character is determined to be “motion PC”, and the target character TC and the player's character PC are caused to make a motion as illustrated in FIG. 5A. When the evaluation result 210 is “A”, the effect image 240 is determined to be “image A”, and the effect image EI illustrated in FIG. 5B is displayed. When the evaluation result 210 is “C”, the effect image 240 is determined to be “image C”, and the effect image EI illustrated in FIG. 5A is displayed.

When the evaluation result 210 is “A”, the game sound to be generated is determined to be “sound A” (e.g., cheer effect sound), and the game sound thus determined is generated. When the evaluation result 210 is “C”, the game sound is determined to be “sound C” (e.g., booing effect sound), and the game sound thus determined is generated. Therefore, the player can be aurally notified of the operation evaluation result.

The points 260 are determined according to the evaluation result 210. The player scores higher points as the evaluation result is better.

In this embodiment, a plurality of target characters are displayed in a different pattern based on the evaluation result.

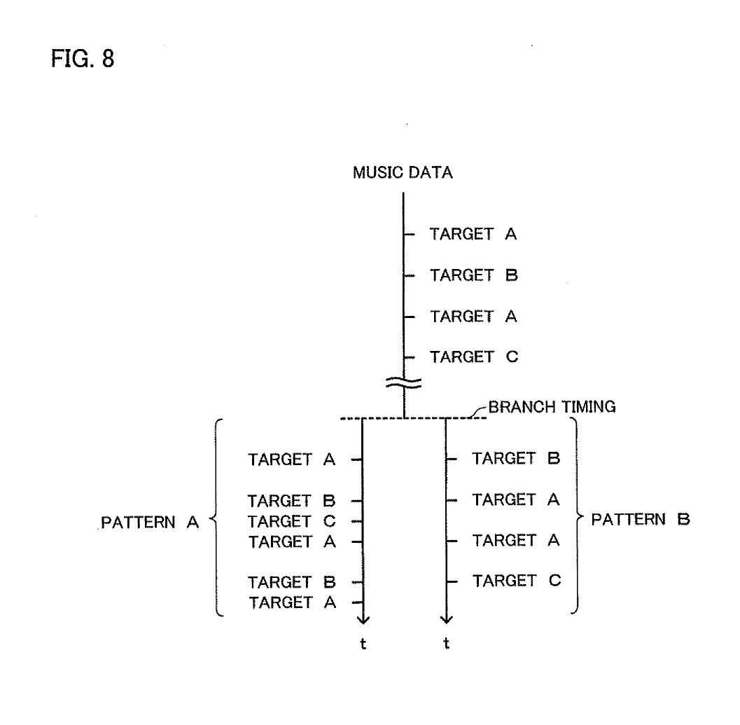

As illustrated in FIG. 8, a plurality of target characters are displayed in a pattern corresponding to the music data to be reproduced, and the appearance pattern of the target characters (i.e., the number, types, positions, and order of the target characters to be displayed) is changed based on the score of the player (i.e., the sum of the points given to the player according to the evaluation result) when a predetermined branch timing has been reached. For example, a branch condition is determined to be satisfied when the score of the player is equal to or larger than a predetermined value, and the target characters are displayed in a pattern A in which the target characters appear with a high frequency. When the score of the player is less than the predetermined value, the target characters are displayed in a pattern B in which the target characters appear with a low frequency. This makes it possible to change the game process and the degree of difficulty of the game based on the skill of the player at a given point in time.

The appearance pattern of the target characters may be changed when the evaluation result or the evaluation result record has satisfied a predetermined branch condition. For example, the branch condition may be determined to be satisfied when the player has performed operations a predetermined number of times at an input timing included within the range Ra illustrated in FIG. 6. The appearance pattern of the target characters may be changed by changing the moving path of the player's character on the map. For example, the player's character may be moved along a path A in which the player's character encounters a special target character (e.g., boss character) when the branch condition has been satisfied, and may be moved along a path B in which the player's character does not encounter the special target character when the branch condition has not been satisfied. This implements a game in which the story of the game branches depending on the operation evaluation result.

In this embodiment, the virtual camera may be controlled according to the operation evaluation result.

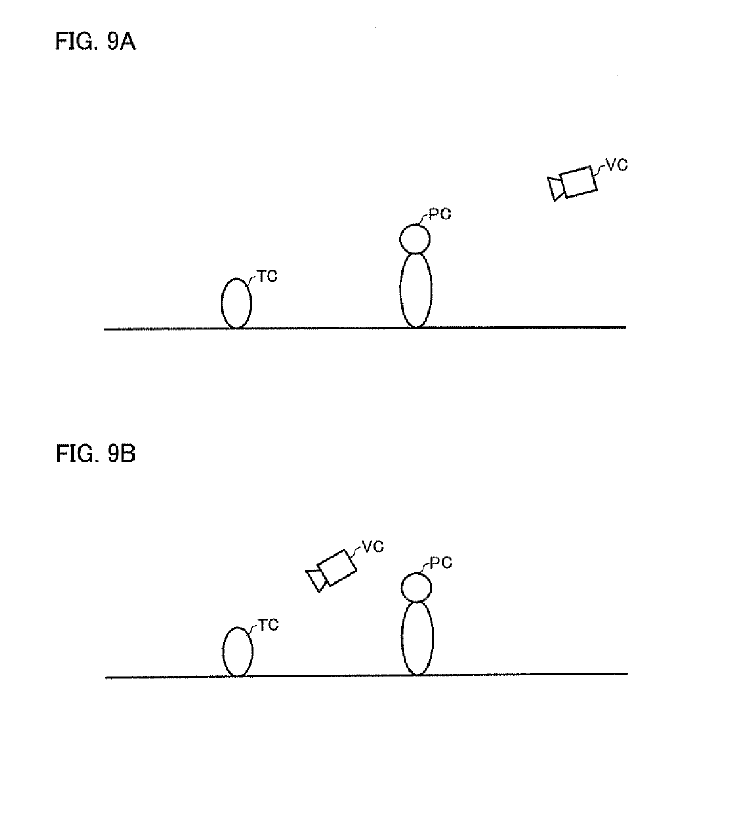

Specifically, the movement of the virtual camera VC is normally controlled so that the virtual camera VC follows the player's character PC from behind the player's character, as illustrated in FIG. 9A. When the player has performed an operation at a timing close to the evaluation timing, the virtual camera VC is moved to a position near the attack target character TC, as illustrated in FIG. 9B. In this case, the angle of view of the virtual camera VC may be changed (e.g., the virtual camera VC zooms in the target character TC) instead of changing the position of the virtual camera VC. This implements a game in which the viewpoint position or the like changes to a large extent depending on the evaluation result.

In this embodiment, a gauge GA that indicates the strength value of the player's character is displayed on the game screen, as illustrated in FIG. 3. The strength value indicated by the gauge GA changes depending on the operation evaluation result. Specifically, the strength value indicated by the gauge GA increases when the player has performed an operation at a timing close to the evaluation timing, and decreases when the player has performed an operation at a timing other than the evaluation timing. When the strength value indicated by the gauge GA has decreased to a value equal to or less than a predetermined value, the game ends (game over). The player clears the game when the strength value indicated by the gauge GA has increased to a value equal to or more than the predetermined value.

### 3. Process

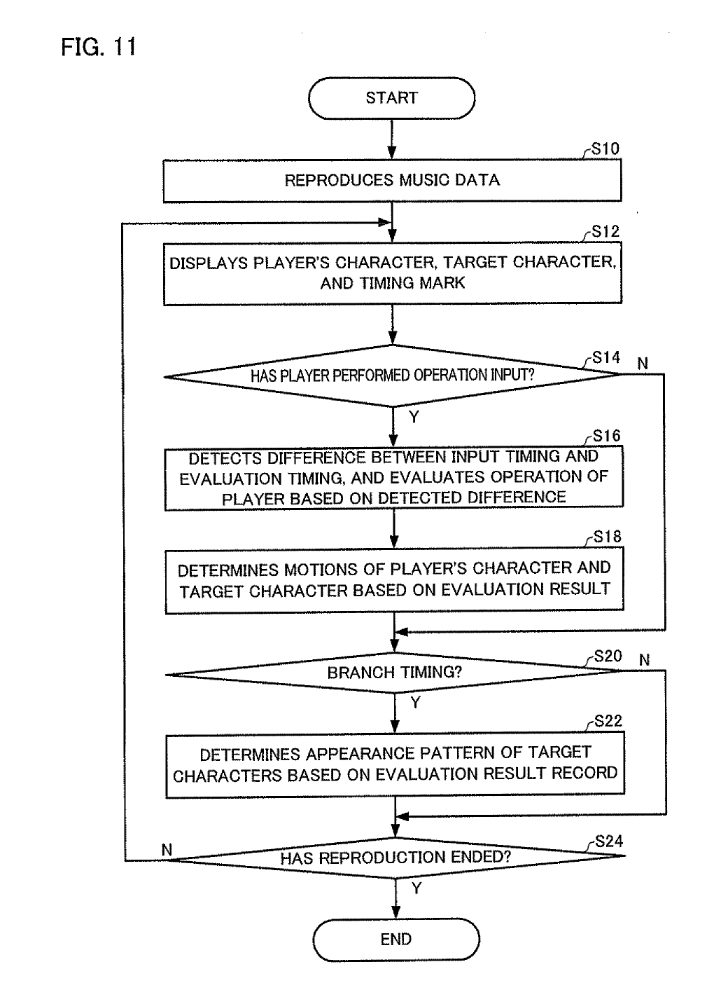

An example of the process according to this embodiment is described below using a flowchart illustrated in FIG. 11.

The music data stored in the storage section is reproduced (step S10). The player's character, the target character, and the timing mark are displayed based on the pattern data corresponding to the music data (step S12).

Whether or not the player has performed an operation input is then determined (step S14). When it has been determined that the player has performed an operation input, the difference between the input timing and the evaluation timing is detected, and the operation of the player is evaluated based on the difference between the input timing and the evaluation timing that has been detected (step S16). The motions of the player's character and the target character are determined based on the evaluation result (step S18).

Whether or not the branch timing has been reached is then determined (step S20). When it has been determined that the branch timing has been reached, the evaluation result record is determined, and the appearance pattern of the target characters is determined based on the evaluation result record (step S22). Whether or not reproduction of the music data has ended is then determined (step S24). When it has been determined that reproduction of the music data has not ended, the process transitions to the step S12, and the step S12 and subsequent steps are repeated. In the step S12, the player's character and the target character are displayed based on the motions of the player's character and the target character determined in the step S18 and the appearance pattern determined in the step S22.

### 4. Modification

The invention is not limited to the above-described embodiments, and various modifications can be made. Any term cited together with a different term having a broader meaning or the same meaning at least once in this specification or drawings can be replaced by the different term in any place in this specification and drawings.

For example, the above embodiments have been described taking the timing mark that indicates a balloon that successively changes in shape until the evaluation timing is reached as an example of the timing mark that indicates the evaluation timing. Note that the timing mark is not limited thereto. For example, a timing mark that successively changes in at least one of size and color until the evaluation timing is reached may also be used. When changing the color of the timing mark, the color tone of the timing mark may be gradually changed (e.g., from red to yellow), or the transparency or the intensity of the timing mark may be gradually changed. The color of the entire timing mark may be changed, or the color of the timing mark may be gradationally changed.

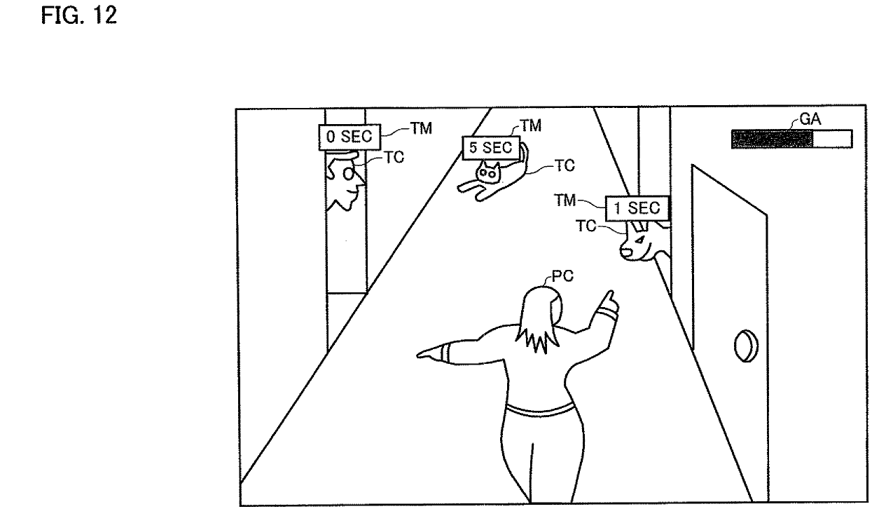

As illustrated in FIG. 12, a timing mark TM that does countdown of the time that remains until the evaluation timing for each target character TC is reached may be displayed in relation to each target character TC. A timing mark TM that indicates the time that remains until the evaluation timing is reached by means of a meter or a gauge may be displayed. The display state of the timing mark may not be changed at a constant speed. The display state of the timing mark may be changed at a different speed for each timing mark.

A special timing mark that differs in display state from a normal timing mark may be provided. When the player has performed an operation at an evaluation timing corresponding to the special timing mark, the motions of the player's character and the target character may be changed to motions that differ from the motions when the player has performed an operation at an evaluation timing corresponding to the normal timing mark.

A first timing mark corresponding to the first controller and a second timing mark corresponding to the second controller (i.e., a timing mark that differs in display state (e.g., color) from the first timing mark) may be displayed, and the operation of the player may be evaluated based on whether or not the player has operated the button of the first controller at an evaluation timing corresponding to the first timing mark, or whether or not the player has operated the button of the second controller at an evaluation timing corresponding to the second timing mark.

The above embodiments have been described taking an example in which one timing mark is displayed in relation to each target character. Note that a plurality of timing marks may be displayed in relation to each target character. In this case, a plurality of timing marks that indicate different evaluation timings may be displayed in relation to each target character, or a plurality of timing marks that indicate an identical evaluation timing may be displayed in relation to each target character. The plurality of timing marks may include the special timing mark or the first and second timing marks.

The above embodiments have been described taking an example in which the timing mark that indicates the evaluation timing is displayed in relation to the target character. Note that the timing mark may be displayed in relation to the player's character.

The above embodiments have been described taking an example in which the player scores points corresponding to the evaluation result based on the operation input timing and the evaluation timing. Note that the player may score points depending on the attribute (e.g., type) of the target character attacked by the player's character. For example, a strength value may be set for each target character, and the player may score higher points when the player's character has defeated a stronger target character. In this case, the target character may be displayed in a display state that differs depending on the attribute of the target character.

The above embodiments have been described taking an example in which the motion of the target character is changed based on the operation evaluation result. Note that the attack target character may be moved to follow the player's character when the operation evaluation result is good (i.e., when the player has performed an operation at an input timing included within the range Ra illustrated in FIG. 6).

The above embodiments have been described taking an example in which the operation of the player is evaluated based on the difference between the button operation input timing and the evaluation timing. Note that the operation of the player may be evaluated based on the difference between the input timing of a touch operation performed by using a touch panel and the evaluation timing. The operation of the player may be evaluated based on the distance between the touch operation indication position and the display position of the attack target character in addition to the difference between the touch operation input timing and the evaluation timing.

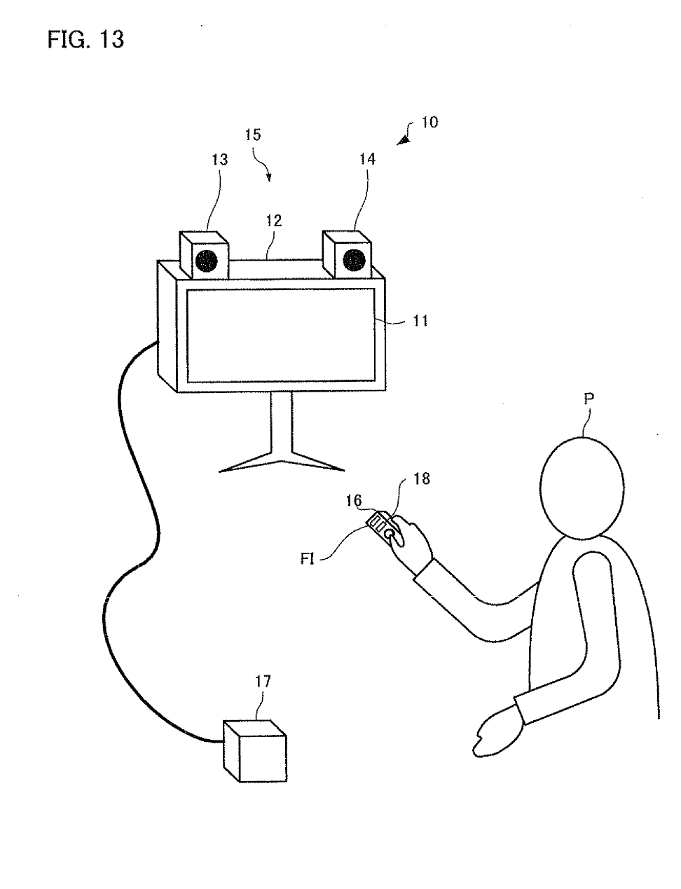

As illustrated in FIG. 13, when a controller 16 held by a player P includes an imaging section 18 that acquires (images) light from light-emitting sections 13 and 14 provided on the top surface of a display section 12 as an image, and a game system 10 calculates the position on a display screen 11 indicated by the controller 16 based on position information about the light-emitting sections 13 and 14 in the image acquired by the imaging section 18 and reference position information, the operation of the player may be evaluated based on the distance between the position indicated by the controller 16 and the display position of the attack target character.

The above embodiments have been described taking an example in which a three-dimensional game image viewed from the virtual camera set in the object space is generated. Note that a two-dimensional game image may also be generated.

Although only some embodiments of this invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. A computer-readable information storage medium storing a program that causes a computer to function as:
a music reproduction section that reproduces music data stored in a storage section;
a character display control section that displays a character disposed on a map;
a timing mark display control section that displays a timing mark in relation to the character, the timing mark indicating an evaluation timing that is set according to the music data;
an input timing acquisition section that acquires an input timing of an input through an operation section; and
an evaluation section that evaluates an operation of a player based on the acquired input timing and the evaluation timing,
the character display control section changing a motion of the character based on an evaluation result of the evaluation section.

2. The information storage medium as defined in claim 1,
wherein the evaluation section detects a difference between the input timing and the evaluation timing; and
wherein the character display control section determines the motion of the character based on the difference between the input timing and the evaluation timing.

3. The information storage medium as defined in claim 1,
wherein the character display control section changes a motion of a target character based on the evaluation result of the evaluation section; and
wherein the timing mark display control section displays the timing mark in relation to the target character.

4. The information storage medium as defined in claim 3,
wherein the evaluation section detects a difference between the input timing and the evaluation timing; and
wherein the character display control section determines the motion of the target character based on the difference between the input timing and the evaluation timing.

5. The information storage medium as defined in claim 3,
wherein the character display control section displays a plurality of the target characters in different patterns based on the evaluation result of the evaluation section.

6. The information storage medium as defined in claim 4,
wherein the character display control section displays a plurality of the target characters in different patterns based on the evaluation result of the evaluation section.

7. The information storage medium as defined in claim 3,
wherein the character display control section displays an effect image in relation to the target character based on the evaluation result of the evaluation section.

8. The information storage medium as defined in claim 4,
wherein the character display control section displays an effect image in relation to the target character based on the evaluation result of the evaluation section.

9. The information storage medium as defined in claim 5,
wherein the character display control section displays an effect image in relation to the target character based on the evaluation result of the evaluation section.

10. The information storage medium as defined in claim 6,
wherein the character display control section displays an effect image in relation to the target character based on the evaluation result of the evaluation section.

11. The information storage medium as defined in claim 1,
wherein the timing mark display control section successively or gradually changes the timing mark until the evaluation timing is reached.

12. The information storage medium as defined in claim 1,
wherein the timing mark display control section changes the timing mark at the evaluation timing.

13. The information storage medium as defined in claim
wherein the character display control section changes a motion of a player's character based on the evaluation result of the evaluation section.

14. The information storage medium as defined in claim 1, storing a program that causes the computer to function as:
a virtual camera control section that controls a virtual camera that generates an image viewed from a given viewpoint in an object space,
wherein the virtual camera control section controls the virtual camera based on the evaluation result of the evaluation section.

15. The information storage medium as defined in claim 1, storing a program that causes the computer to further function as:
a sound generation section that generates game sound based on the evaluation result of the evaluation section.

16. A game system comprising:
a music reproduction section that reproduces music data stored in a storage section;
a character display control section that displays a character disposed on a map;
a timing mark display control section that displays a timing mark in relation to the character, the timing mark indicating an evaluation timing that is set according to the music data;
an input timing acquisition section that acquires an input timing of an input through an operation section; and
an evaluation section that evaluates an operation of a player based on the acquired input timing and the evaluation timing,
the character display control section changing a motion of the character based on an evaluation result of the evaluation section.

17. A method of controlling a game system, the method comprising:
reproducing music data stored in a storage section;
displaying a character disposed on a map;
displaying a timing mark in relation to the character, the timing mark indicating an evaluation timing that is set according to the music data;
acquiring an input timing of an input through an operation section;
evaluating an operation of a player based on the acquired input timing and the evaluation timing; and
changing a motion of the character based on an evaluation result for the operation of the player.
